(19) United States
(12) Patent Application Publication
(10) Pub. No.: US 2015/0192452 A1
(43) Pub. Date: Jul. 9, 2015

(54) Filling Level Measurement

(71) Applicant: KSB Aktiengesellschaft, Frankenthal (DE)

(72) Inventors: Franz Bosbach, Freinsheim (DE); Stefan Laue, Neuleiningen (DE); Gerhard Lindner, Coburg (DE); Frank Obermair, Kapsweyer (DE); Joachim Schullerer, Rheinzabern (DE)

(73) Assignee: KSB Aktiengesellschaft, Frankenthal (DE)

(21) Appl. No.: 14/412,864

(22) PCT Filed: Jun. 26, 2013
(86) PCT No.: PCT/EP2013/063345

§ 371 Date: Jan. 5, 2015

(30) Foreign Application Priority Data
Jul. 6, 2012 (DE) 10 2012 211 848.9

(51) Int. Cl. G01F 23/296

(52) U.S. Cl. CPC G01F 23/2962

(57) ABSTRACT

Apparatus and method for determining the filling level of a liquid in a container is provided. The apparatus includes at least one element coupled with a body at least partially immersed in the liquid, the at least one element transmitting and/or receiving acoustic signals. The at least one element may include an element that both transmits and receives acoustic signals, and may include elements that have a transmitting-only element and a receiving-only element. The acoustic signals generated by the at least one element propagate along a surface of the body, which may be solid or hollow. The body is arranged in such a manner that at least one part of a surface can be wetted by the liquid. The body has, at different container heights, regions which reflect the acoustic signals that may be detected and analyzed by a unit to determine the container liquid level.

This application is a National Stage of PCT International Application No. PCT/EP2013/063345, filed Jun. 26, 2013, which claims priority under 35 U.S.C. §119 from German Patent Application No. 10 2012 211 848.9, filed Jul. 6, 2012, the entire disclosures of which are herein expressly incorporated by reference.

The invention relates to an apparatus and a method for determining the level of a liquid in a container with at least one element that sends and/or receives acoustic signals.

Such apparatuses are used with waste water lifting equipment for example. Lifting equipment discharges waste water that falls below the flood level with protection against reverse flow. They are used to convey waste water containing feces that occurs in the cellars of residential buildings.

In the case of conventional lifting equipment, the level measurement and regulation take place by means of a float switch. A measurement method with moving mechanical components is used for this. These are susceptible to contaminants, such as occur in the waste waters of lifting equipment.

German patent publication no. DE 10 2007 008 692 A1 describes a container of a lifting equipment, in which sensors for the detection of the liquid level are mounted on the outside of the wall at different container heights. Said measurement device is fixedly joined to the container. A flexible use of the apparatus for a number of containers is thus excluded. The large number of sensors with said system is thus disadvantageous.

In German patent publication no. DE 199 13 530 A1 a lifting equipment with a plastic collection container is described. Liquid flows to the collection container at irregular intervals. The liquid is conveyed from the container into a network of channels by a pump. An element that is disposed on the top of the container is used for measurement of the liquid level in the container. The element transmits radar waves that are reflected from the surface of the liquid. The reflected waves are in turn received by the element. The level is determined from the transition time of the waves. The pump is switched on or off depending on the level. Methods for level detection with radar waves are complex.

Furthermore, apparatuses for level measurement are known, with which an element that transmits ultrasonic signals is mounted on the top of the container. Said acoustic signals are reflected by the surface of the liquid and detected by the element. The ultrasonic level measurement is a contactless method that works on the transition time principle. Here too there is a risk of erroneous measurements of the liquid level because of floating foam that reflects the ultrasonic waves.

The object of the invention is to specify an apparatus for level measurement that is insensitive to contaminants and also delivers reliable measurement values in the event of the formation of foam. In addition, the apparatus should be inexpensive to manufacture and should be characterized by reliability and a long service life.

This object is achieved according to the invention by the acoustic signals propagating along a surface of a solid body that is disposed so that at least part of a surface of the solid body is wetted by the liquid and the solid body comprises regions at different container heights that reflect the acoustic signals.

According to the invention, surface acoustic waves (SAW) are used for level measurement. With this the acoustic signals propagate on the surface of a solid body.

The solid body may consist of a composite material. However, it will preferably be formed of a single material, wherein it has been proved to be particularly advantageous to use a solid body made of a metal.

The solid body can have different geometric shapes, for example cuboid or cylindrical. In the case of a preferred implementation of the invention it is a hollow body, wherein in particular a hollow cylinder, i.e. a tube, has proved advantageous.

In the case of one version of the invention the hollow body is closed by a bottom. In this way liquid is prevented from penetrating into the hollow body. The elements that produce and/or detect the acoustic surface waves are mounted on the inside. Thus the acoustic signals propagate on the inner, dry surface of the tube and are reflected by regions that the tube comprises on its inside. The measurement tube is immersed in the liquid, wherein only the outside is wetted. Surprisingly, it has been determined that the acoustic surface waves are strongly attenuated below the level of the liquid, even though they propagate on the dry inside of the tube. The prerequisite for this is that the wall thickness of the tube is not too great.

According to the invention the solid body is disposed so that at least part of a surface can be wetted by the liquid. This can be the surface of the solid body on which the SAW propagate and/or another surface, which is for example opposite the same.

The solid body comprises regions that reflect the surface waves. For this purpose the solid body comprises suitable, especially sharp-edged changes of geometry. Preferably, the regions are depressions that are incorporated in the surface. Approximately horizontal elongated depressions are most suitable for this. In the case of a particularly advantageous version, indentations are cut and/or punched into the surface, wherein notches have proved to be especially favorable. A groove can also be incorporated as an indentation in the solid body. The regions can also be in the form of elevations of the surface of the solid body.

In principle it is also possible that the solid body is formed of a piece of the wall of the container. However, it has proved particularly favorable if the solid body is in the form of a separate component that is disposed in the container. The solid body is at least partly immersed in the liquid and comprises reflective regions at different container heights. In the case of the part of the solid body that is not immersed in the liquid, the acoustic signals are reflected at the notches without attenuation. The reflected signals are detected by a detector that is either formed by the same element that produces the SAW or as a separate element.

In the case of the part of the solid body that is immersed in the liquid, the acoustic signals are strongly attenuated by the liquid. In this case we speak of “decoupling” of the signals. Thus signals reflected by the regions below the level of the liquid are strongly attenuated.

The reflected signals are analyzed or evaluated by a unit. The unit is configured so that it determines the level from the wave pattern of the reflected signals. The wave pattern means the detection of the intensities of all reflected acoustic signals depending on the transition times. Acoustic signals that are reflected by reflection points near the bottom region of the container have a longer transition time than acoustic signals from further above. The acoustic signals reflected at the regions are also referred to as echoes.

Below the liquid level the echoes are strongly attenuated. Using a comparison with reference measurements that are carried out with a completely empty container for example, the unit can determine the level because the signals of the reflection regions below the level of the liquid are strongly attenuated compared to the reference values.

With the method according to the invention, the following steps are carried out.
producing acoustic signals,
propagating the acoustic signals along a surface of a solid body,
at least partial reflection of signals at regions of the solid body that are disposed at different container heights,
detection of the reflected signals,
determining the transition times of the reflected signals,
determining the signal strengths of the reflected signals,
comparison with reference values,
determining the fill level

This is a procedure that is repeatedly run through at regular time intervals.

The solid body preferably has a longitudinal extent and is disposed vertically in the container. The position of the reflection regions is also decisive for the quality of the analysis. The same can be disposed in the direction of propagation of the acoustic signals and in parallel with each other and one above the other. However, the reflected signals overlay each other in the case of such an arrangement. An analysis of the wave pattern is therefore more difficult. In the case of a particularly advantageous implementation of the invention, the reflective regions are disposed laterally offset with respect to each other in relation to the direction of propagation of the acoustic signals. The superimpositions of the reflected signals are reduced in this way. At least some of the reflected signals pass to the detector without multiple reflections occurring. In this way a wave pattern is obtained with which the individual echoes can be distinguished well.

The elements for producing the acoustic surface waves preferably consist of a piezoelectric substrate on which a comb electrode is mounted as a transmitter. This forms an interdigital transducer (IDT), the so-called transmitter interdigital transducer (transmitter IDT), which produces a surface wave on the piezoelectric substrate.

The stimulation frequency is selected such that Lamb waves or surface waves are preferably produced in the transition region between Lamb waves and Rayleigh waves.

In the case of one version of the invention, the elements are disposed on the surface of the solid body. In addition the piezoelectric substrate is acoustically conductively joined to the solid body. This can be achieved with an adhesive. The surface waves are transferred from the piezoelectric substrate to the solid body and propagate on a surface of the solid body.

The echoes are detected by an element that acts as a detector. Said detector also comprises a piezoelectric substrate with a comb electrode. It functions as a receiver interdigital transducer (receiver IDT) and converts the received acoustic surface waves into electrical signals. In the case of one version of the invention, the detector is also directly mounted on the solid body, for example by means of an adhesive.

In the case of an alternative implementation of the invention, at least one of the elements is disposed on the surface of a head part. Said head part can be acoustically coupled to the solid body. The coupling can be implemented by means of a greased or glued ground socket. The head part can thereby be connected to different solid bodies. Thus for example a plurality of measurement tubes with different lengths can be coupled to the head part, so that only one electronic transmitting and receiving means is required. Different measurement lengths can thus be achieved with one head part. In the case of a particularly favorable version, the unit is configured to detect the type of the connected measurement tube by means of the echo wave pattern in the manner of a barcode.

Instead of a separate SAW transmitter and receiver, a common electroacoustic transducer can also be used, which is alternately switched as a transmitter and receiver in multiplex mode.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a section through a measurement tube for level measurement in accordance with an embodiment of the present invention,

FIG. 2 shows a wave pattern of a measurement in accordance with an embodiment of the present invention,

FIG. 3 shows a lifting equipment with a level measurement device in accordance with an embodiment of the present invention,

FIG. 4 shows an arrangement of the reflective regions in accordance with an embodiment of the present invention.

### DETAILED DESCRIPTION

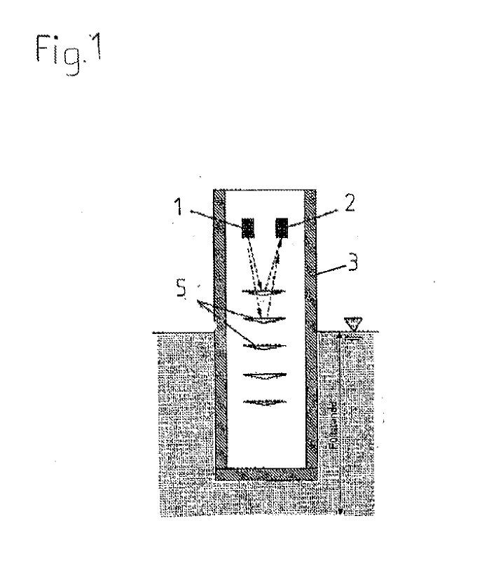

In FIG. 1 an apparatus for determining the level of a liquid is illustrated. A first element 1 is used as a transmitter and produces acoustic signals. A second element 2 is used as a detector and receives reflected acoustic signals. Both elements 1, 2 comprise a piezoelectric substrate in which a comb electrode is inserted in each case. They form interdigital transducers (IDT=interdigital transducer) for converting electrical signals into acoustic signals in the case of the transmitter or for converting acoustic signals into electrical signals in the case of the receiver.

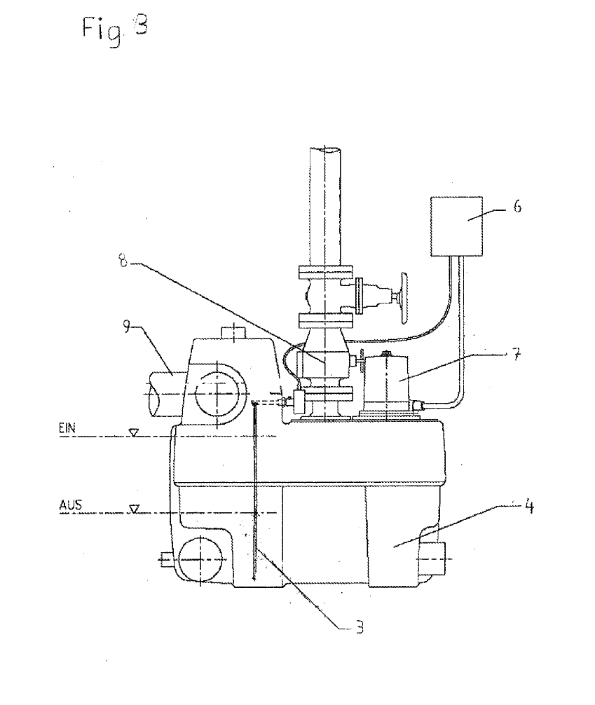

The elements 1, 2 are mounted on a solid body 3. The solid body 3 is implemented as a cylindrical hollow body whose bottom is closed and that is open at the top and thus forms a measurement tube. The measurement tube is disposed in a container 4 that is illustrated in FIG. 3. The measurement tube consists of aluminum and is oriented vertically in the container 4.

Regions 5 that reflect the acoustic signals are disposed on the inside of the measurement tube. The regions 5 are notches that are milled in the measurement tube. The regions 5 are disposed one above the other and mutually parallel so that multiple reflections that interfere with each other occur in the embodiment illustrated in FIG. 1.

In FIG. 1 five reflective regions 5 are illustrated by way of example, of which two are disposed above the level of the liquid and three below the level of the liquid. The echoes of the upper two regions show a high signal strength. The echoes of the lower three regions only show a low signal strength, because the acoustic waves are attenuated by the liquid on the outside of the tube. Although the SAW propagate on the inside of the measurement tube and the liquid wets the outside of the measurement tube, the attenuation is so significant that it can be used for determining the level.

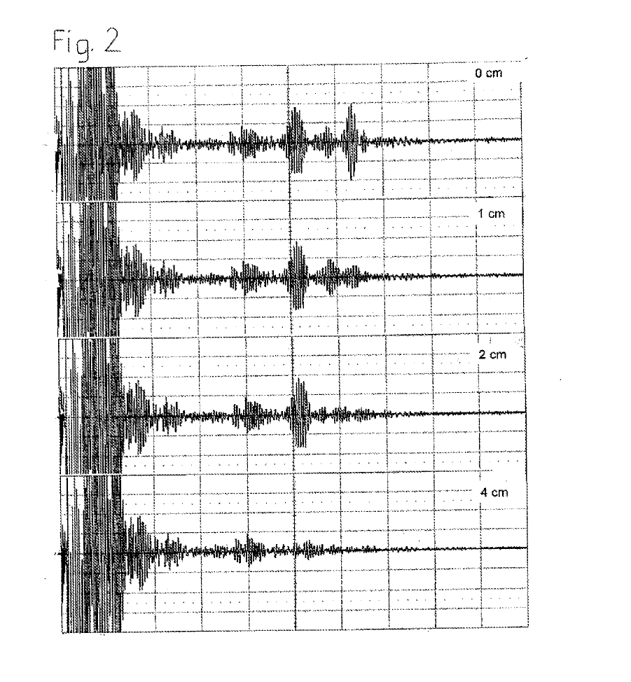

FIG. 2 shows wave patterns of the reflected acoustic signals for different fill levels. The fill levels are each indicated in centimeters above and to the right next to the respective wave pattern.

In the case of the wave patterns the signal strengths are each plotted as a function of the transition times of the signals. Wave groups that are reflected by regions further down on the solid body 3 have longer transition times and are consequently located further to the right in the diagrams. Wave groups that are reflected by regions further up on the solid body 3 have shorter transition times and are consequently located further to the left in the diagrams.

The signal strength is given in mVpp in the exemplary embodiment because the detector converts the received acoustic signals into electrical signals that are recorded in millivolts from peak to peak.

The top wave pattern with a level of 0 cm is used as a reference because none of the reflected wave groups are attenuated by liquid. In the case of a liquid level of 1 cm, the wave group at the far right is highly attenuated, so that its signal strength decreases. In the case of a level of 2 cm the two right wave groups are attenuated and in the case of a level of 4 cm the three right wave groups are attenuated.

A unit 6 determines the level by comparison of the determined wave pattern with reference values. The unit 6 is schematically illustrated in FIG. 3. This can be a computer, a regulating device or a control device. The unit 6 is configured to record the signal strength of the reflected signals as a function of the transition times and to determine the level by comparison with reference values. The more reflected wave groups are attenuated, the higher is the level. The level can be calculated using the number of the unattenuated and/or attenuated wave groups.

In the case of a particularly advantageous version of the invention, the unit 6 is also used for control and/or regulation of the level. FIG. 3 shows that the unit 6 is connected to a motor 7 of a pump disposed in the interior of the container 4. In the exemplary embodiment an electric motor that drives a centrifugal pump is used for this. The unit 6 switches the motor 7 on and off.

A check valve 8 is disposed downstream of the pump. A feed pipe 9 through which liquid flows into the container 4 is connected to the container 4 of the lifting equipment.

The solid body 3 implemented as a measurement tube detects the level according to the principle described above. At a lower limit value of the liquid level the unit 6 stops the motor 7. At an upper limit value of the liquid level the unit 6 starts the motor 7, so that liquid is pumped out again.

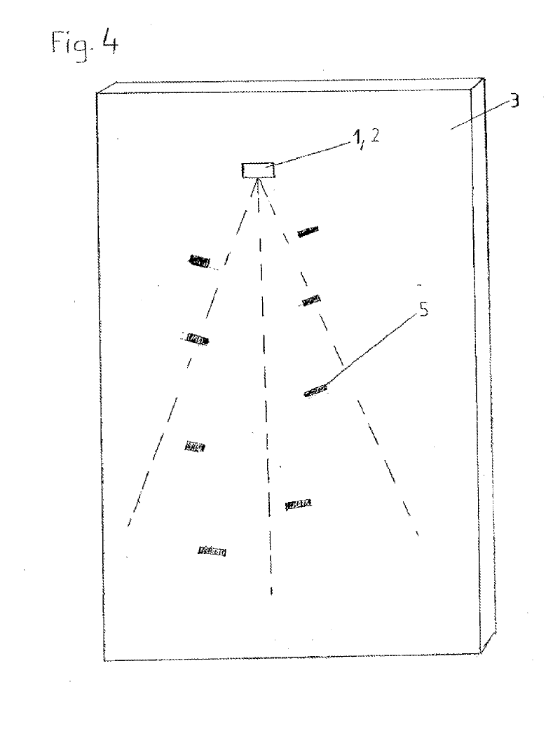

FIG. 4 shows a version in which the reflective regions are disposed offset. Instead of a separate SAW transmitter and receiver, in this case a common electroacoustic transducer is used as the element 1, 2 that is alternately switched as a transmitter and receiver in multiplex mode. The solid body 3 is a plate of aluminum with a thickness of 1 mm. The plate can be rolled into a tube. In this case the elements 1, 2 are disposed on the inside of the tube. The IDT is glued onto the solid body and has a radiation characteristic consisting of lobes, which is illustrated as dashed lines and has an angle of approx. 30°. The regions 5 are disposed laterally offset from each other in relation to the direction of propagation of the acoustic signals, so that the transmitted wave group reaches each region 5 directly. This ensures that the echoes pass directly back to the IDT without multiple reflections occurring.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-15. (canceled)

16. An apparatus for determining a level of a liquid in a container, comprising:
at least one acoustic signal element, said at least one element being element capable of transmitting and receiving acoustic signals; and
a body configured to be at located in the container, the body comprising regions at different container heights,
wherein
the at least one element is arranged at least one of on and in the body such that acoustic signals transmitted from the at least one element propagate along a surface of the body and reflect acoustic signals toward the at least one element.

17. The apparatus as claimed in claim 16, wherein
at least one of the at least one elements is connected to a unit configured to detect the signal strength of the reflected signals received at the at least one of the at least one elements and to determine the container liquid level by comparison of transition times between transmission and receipt of the acoustic signals with predetermined reference time values.

18. The apparatus as claimed in claim 16, wherein
the body is disposed in an interior of the container.

19. The apparatus as claimed in claim 18, wherein
the body is hollow.

20. The apparatus as claimed in claim 19, wherein
the hollow body is closed by a bottom that prevents penetration of the liquid into the hollow body.

21. The apparatus as claimed in claim 16, wherein
the regions in depressions in the surface of the body.

22. The apparatus as claimed in claim 16, wherein
the regions are elevations of the surface of the solid body.

23. The apparatus as claimed in claim 16, wherein
the regions are laterally offset with respect to each other relative to a direction of propagation of the acoustic signals.

24. The apparatus as claimed in claim 16, wherein
at least one of the at least one elements is disposed on the surface of the solid body.

25. The apparatus as claimed in claim 16, wherein
at least one of the at least one elements is disposed on a surface of a head part of the body in a manner permitting acoustic coupling of the at least one of the at least one elements to the body.

26. A method for determining the level of a liquid in a container with an apparatus having a body configured to be at located in the container, the body comprising regions at different container heights, and at least one acoustic signal element, said at least one element being element capable of transmitting and receiving acoustic signals and being arranged at least one of on and in the body such that acoustic signals transmitted from the at least one element propagate along a surface of the body and reflect acoustic signals toward the at least one element, comprising the acts of:
producing acoustic signals from the at least one element,
propagating the signals along the surface of the body;
at least partially reflecting the signals at the regions of the body disposed at different container heights; and
detecting the at least partially reflected signals.

27. The method as claimed in claim 26, further comprising the act of:
determining transition times between producing and detecting the signals.

28. The method as claimed in claim 27, further comprising the act of:
determining signal strengths of the reflected signals.

29. The method as claimed in claim 28, wherein
the determined signal strengths of the at least partially reflected signals are correlated to their respective transition times.

30. The method as claimed in claim 29, further comprising the ac of:
determining the container liquid level comparing the respective transition times with predetermined reference time values.
